(19) United States
(12) Patent Application Publication
(10) Pub. No.: US 2026/0203641 A1
(43) Pub. Date: Jul. 16, 2026

(54) FRAMEWORK FOR MANAGING MACHINE LEARNING PERCEPTION TASKS ON LIMITED HARDWARE RESOURCES

(71) Applicant: Google LLC, Mountain View, CA (US)

(72) Inventors: Shishir Rao Ayalasomayajula, Cupertino, CA (US); Ankit Arora, San Francisco, CA (US)

(21) Appl. No.: 19/018,478

(22) Filed: Jan. 13, 2025

(51) Int. Cl. G06N 20/00

(52) U.S. Cl. CPC G06N 20/00

(57) ABSTRACT

Techniques for managing machine learning (ML) perception tasks on limited hardware resources are disclosed herein. An example system includes one or more processors that execute instructions to: register, to a registry, for each of a plurality of ML task processors, an indication of a semantic output generated by the ML task processor; receive, by a task management module and from a client, a request for particular semantic output; identify, based on the registry, a ML task processor, wherein the indication of the semantic output for the ML task processor corresponds to the particular semantic output; responsive to determining the ML task processor is currently executing, refrain from loading the ML task processor; responsive to determining the ML task processor is not currently executing, execute the ML task processor; and establish a connection between the client and the ML task processor to allow the client to receive the semantic output.

### BACKGROUND

A standalone and embedded computing device may be connected to a variety of sensors (e.g., imaging devices, proximity sensors, location sensors) that allow the computing device to collect data about the surrounding environment. The collected data may be advantageous to the functionality of the computing devices. For example, in combination with machine learning techniques, the computing device may perceive and respond to elements of the surrounding environment.

### SUMMARY

In general, aspects of the techniques of this disclosure are directed to managing machine learning (ML) perception tasks on limited hardware resources. For example, a computing device of a software defined vehicle may execute a number of applications that rely upon a semantic understanding of a scene around the vehicle for proper operation. Rather than consuming computing resources (e.g., processing, memory) to determine such semantic understanding at each of these applications independently, the computing device may manage ML tasks to more effectively utilize the limited computing resources of the computing device.

For example, a computing device may include a task management module that registers (e.g., stores), to a registry, one or more characteristics of ML task processors that provide semantic output about the scene. These characteristics may, among other things, indicate the type of semantic output generated by each of the ML task processors. Rather than automatically executing the ML task processor, the task management module may determine, based on the registry, whether a ML task processor that provides semantic output corresponding to the client's request is currently executing (e.g., currently running). When the task processor is currently executing, the task management module may establish a connection between the client and the task processor, thereby eliminating the need to execute another task processor to provide the requested semantic output to the client.

In some aspects, the techniques described herein relate to a method including: registering, by a computing system and to a registry, for each respective machine learning task processor from a plurality of machine learning task processors, an indication of a semantic output generated, by the respective machine learning task processor and based on sensor data collected by one or more sensors, to describe one or more aspects of the sensor data perceived by the respective machine learning task processor; receiving, by a task management module of the computing system and from a client executing on the computing system, a request for particular semantic output; identifying, by the computing system and based on the registry, a machine learning task processor from the plurality of machine learning task processors, wherein the indication of the semantic output for the machine learning task processor corresponds to the particular semantic output; determining, by the computing system, whether the machine learning task processor is currently executing at the computing system; responsive to determining the machine learning task processor is currently executing at the computing system, refraining, by the computing system, from loading the machine learning task processor for execution at the computing system; responsive to determining the machine learning task processor is not currently executing at the computing system, executing, by the computing system, the machine learning task processor; and establishing, by the computing system, a connection between the client and the machine learning task processor, wherein the client receives the semantic output of the machine learning task processor via the connection.

In some aspects, the techniques described herein relate to a computing system including a memory that stores instructions; and one or more processors that execute the instructions to: register, to a registry, for each respective machine learning task processor from a plurality of machine learning task processors, an indication of a semantic output generated, by the respective machine learning task processor and based on sensor data collected by one or more sensors, to describe one or more aspects of the sensor data perceived by the respective machine learning task processor; receive, by a task management module of the computing system and from a client executing on the computing system, a request for particular semantic output; identify, based on the registry, a machine learning task processor from the plurality of machine learning task processors, wherein the indication of the semantic output for the machine learning task processor corresponds to the particular semantic output; determine whether the machine learning task processor is currently executing at the computing system; responsive to determining the machine learning task processor is currently executing at the computing system, refrain from loading the machine learning task processor for execution at the computing system; responsive to determining the machine learning task processor is not currently executing at the computing system, execute the machine learning task processor; and establish a connection between the client and the machine learning task processor, wherein the client receives the semantic output of the machine learning task processor via the connection.

In some aspects, the techniques described herein relate to non-transitory computer-readable storage media including instructions, that when executed by one or more processors of a computing system, cause the one or more processors to: register, to a registry, for each respective machine learning task processor from a plurality of machine learning task processors, an indication of a semantic output generated, by the respective machine learning task processor and based on sensor data collected by one or more sensors, to describe one or more aspects of the sensor data perceived by the respective machine learning task processor; receive, by a task management module of the computing system and from a client executing on the computing system, a request for particular semantic output; identify, based on the registry, a machine learning task processor from the plurality of machine learning task processors, wherein the indication of the semantic output for the machine learning task processor corresponds to the particular semantic output; determine whether the machine learning task processor is currently executing at the computing system; responsive to determining the machine learning task processor is currently executing at the computing system, refrain from loading the machine learning task processor for execution at the computing system; responsive to determining the machine learning task processor is not currently executing at the computing system, execute the machine learning task processor; and establish a connection between the client and the machine learning task processor, wherein the client receives the semantic output of the machine learning task processor via the connection.

The details of one or more examples of the subject matter of this specification are set forth in the accompanying drawings and the description below. Other features, aspects, and advantages of the subject matter will become apparent from the description, the drawings, and the claims.

### BRIEF DESCRIPTION OF DRAWINGS

FIG. 1 is a conceptual diagram illustrating an example environment for managing machine learning perception tasks on limited hardware resources, in accordance with one or more aspects of the present disclosure.

FIG. 2 is a block diagram illustrating an example computing device, in accordance with one or more aspects of the present disclosure.

FIG. 3 is a block diagram illustrating an example task processor, in accordance with one or more aspects of the present disclosure.

FIG. 4 is a block diagram illustrating a first example of a processing pipeline, in accordance with one or more aspects of the present disclosure.

FIG. 5 is a block diagram illustrating a second example of a processing pipeline, in accordance with one or more aspects of the present disclosure.

FIG. 6 is a flowchart of an example process for managing machine learning perception tasks on limited hardware resources, in accordance with one or more aspects of the present disclosure.

### DETAILED DESCRIPTION

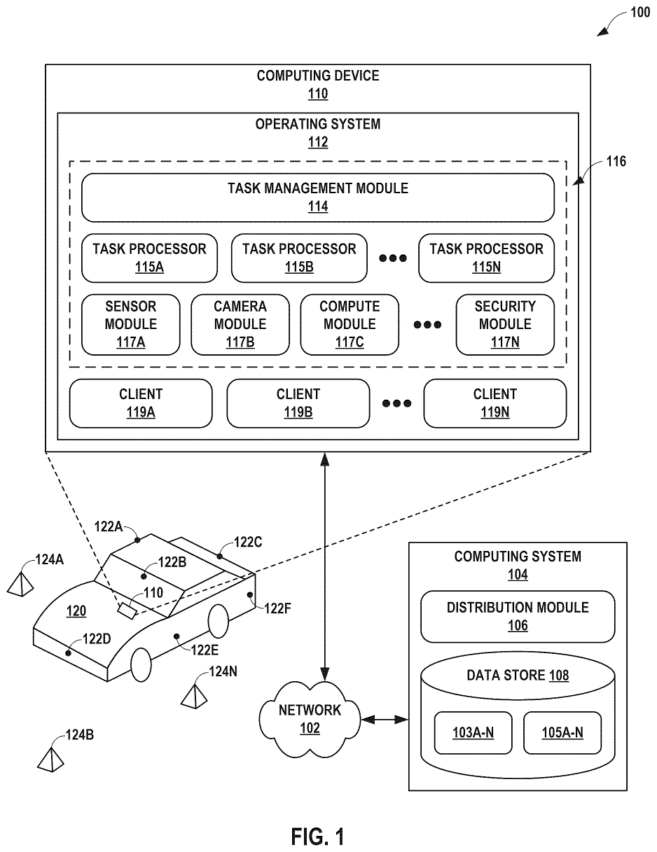

FIG. 1 is a conceptual diagram illustrating an example environment for managing machine learning perception tasks on limited hardware resources, in accordance with one or more aspects of the present disclosure. As can be seen, environment 100 may include a computing device 110, a computing system 104, and a network 102. As described herein, computing system 104 may host (e.g., implement) one or more services that computing device 110 may access, such as through network 102.

Computing device 110 may be a computer or other computing device installed in a vehicle 120, including an electronic control unit (ECU), navigation system, or infotainment system. FIG. 1 illustrates a particular example of computing device 110, and many other examples of computing device 110 may be used in other instances and may include a subset of the components included in computing device 110 or may include additional components not shown in FIG. 1. Computing device 110 may include a cluster or other combination of computing or other devices or systems and may also be referred to herein as a computing system or “computing system 110.” Some other examples of computing device 110 include a mobile phone, a tablet computer, a laptop computer, a wearable device, a gaming system, a media player, an e-book reader, or any other type of computing device that may operate in accordance with the present disclosure.

Computing device 110 may include operating system 112. Computing device 110 may execute operating system 112 to perform various actions or functions. For example, computing device 110 may execute operating system 112 to provide an execution environment for a task management module 114, one or more task processors 115A-115N (collectively, “task processors 115”), and one or more clients 119A-119N (collectively, “clients 119”), or various subsets thereof. As will be described further below, task management module 114 may execute, terminate, monitor, or otherwise manage task processors 115. Task processors 115 may also be referred to herein as machine learning (ML) task processors 115A-115N (collectively, “ML task processors 115”). Computing device 110 may execute task processors 115 to semantically interpret a scene (e.g., environment) around vehicle 120.

One or more of task processors 115 may apply one or more ML techniques to generate output for one or more of clients 119 and may also be referred to herein as ML task processors 115A-115N (collectively, “ML task processors 115”). For example, task processor 115A may receive sensor data collected by one or more of a plurality of sensors 122A-122N (collectively, “sensors 122”) as input and apply one or more ML techniques (e.g., inferencing, classification, object recognition) to the sensor data to describe one or more aspects of the sensor data perceived application of the one or more ML techniques. For instance, task processor 115A may generate semantic output describing the one or more aspects of the sensor data. To illustrate, task processor 115A may apply a ML model (e.g., inferencing model, classification model, object recognition model) to generate semantic output that identifies one or more objects 124A-124N (collectively, “objects 124”) and/or one or more features (e.g., characteristics) of objects 124 from the sensor data. Task processors 115 may generate semantic output labeling, describing, or otherwise identifying objects 124 or features thereof, from the sensor data. A task processor of task processors 115 may generate semantic output that is relevant to a task of the task processors. For example, in connection with vehicular activity (e.g., driving) at vehicle 120, task processor 115A may perform an object recognition task to identify, objects 124 representing people, vehicles, pedestrians, animals, fire hydrants, traffic lanes, traffic signs, traffic obstructions, or other objects relevant to the object recognition task of task processor 115A.

Sensors 122 may capture a variety of sensor data. For example, sensors 122 may capture sensor data about a scene related to computing device 110 (e.g., the scene where computing device 110 is physically located). For instance, sensors 122 may capture sensor data about the street, highway, road, trail, path, or other environment where computing device 110 of vehicle 120 is located. Examples of sensors 122 include imaging sensors (e.g., cameras), range sensors (e.g., light detection and ranging (LIDAR), radio detection and ranging (RADAR), ultrasonic sensor), presence sensors (e.g., infrared sensor), light sensors, location sensors (e.g., global navigation satellite system (GNSS) receiver), inertial measurement units (IMUs) (e.g., accelerometers, gyroscopes, magnetometers), sound sensors (e.g., microphones), or other sensing devices suitable to collect sensor data for use as input for one or more of task processors 115. In some examples, sensors 122 may constitute a sensor suite (e.g., combination of sensors 122), which may be selected for a particular task. For example, computing device 110 may include a sensor suite including a combination of one or more imaging, range, and/or location sensors 122 to provide autonomous driving or driver assistance services at vehicle 120.

One or more of sensors 122 may be included with computing device 110. As shown in FIG. 1 for example, one or more of sensors 122 may be mounted to vehicle 120 where computing device 110 is installed. For instance, one or more imaging, range, location, and/or other sensors 122 may be mounted to vehicle 120. Though not shown, one or more of sensors 122 may additionally or alternatively be mounted to an enclosure or other structure of computing device 110. For example, assuming for illustration purposes computing device 110 is a laptop computer, tablet, or smartphone, one or more imaging, range, location, and/or other sensors 122 may be mounted to an enclosure or other structure of computing device 110.

Clients 119 may represent respective applications, modules, services, or the like that may be implemented by (e.g., executed on) computing device 110. In general, clients 119 may rely upon or otherwise use one or more of task processors 115 to perform one or more functions. Clients 119 may obtain access to one or more of task processors 115 through task management module 114. For example, client 119A may request semantic output that identifies objects 124 in sensor data captured by one or more of sensors 122. In response, task management module 114 may determine which of task processors 115 provides semantic output that corresponds to the requested semantic output. For example, task management module 114 may determine task processor 115A provides the semantic output that matches the requested semantic output in that the semantic output of task processor 115A generates output identifying one or more of objects 124 perceived from sensor data.

Examples of clients 119 include mapping applications that provide street or other maps, driver assistance applications that provide turn-by-turn navigation instructions, visualization applications that provide surround or other views around vehicle 120, and safety applications that record and/or monitor the scene around vehicle 120. Clients 119 may use semantic output from one or more of task processors 115 to semantically interpret a scene captured by one or more of sensors 122. For example, a mapping application may obtain semantic information about road signs and lane markings through the semantic output, such as to update one or more maps provided by the mapping applications. The mapping application may detect and obtain semantic information about traffic incidents (e.g., construction zones, road closures, accidents) through the semantic output, which may be used for crowd-sourced or other route planning services. A driver assistance application may recognize objects in a scene based on the semantic output and present an overlay of information (e.g., lane level navigation instructions), such as through a heads up display (HUD) or other display, to augment the driver's view of the scene. A visualization application may provide an immersive three dimensional (3D) view of the scene by stitching imaging data (e.g., photos, video) using coarse depth estimations of objects in the scene based on the semantic output. A safety application may obtain a semantic understanding of a traffic or parked scene based on the semantic output, such as to trigger and/or tag video recordings with event tags.

Clients 119 may execute concurrently on computing device 110. Such concurrent execution would result in high computing resource consumption if each of clients 119 were to independently determine a semantic understanding of a relevant scene. As such, task management module 114 may manage task processors 115 such that concurrently executing (e.g. currently running) clients 119 may use the semantic output of a single task processor of task processors 115 to obtain a semantic understanding of a scene.

Task management module 114 may execute a task processor of task processors 115 in response to a request from one or more of clients 119. Rather than automatically executing the task processor in response to the request, task management module 114 may first determine whether one or more of task processors 115 that are currently executing at computing device 110 provide semantic output that is responsive to the request. Continuing the above example for instance, task management module 114 may determine whether task processor 115A, which provides semantic output matching the semantic output requested by client 119A, is currently executing. In response to determining task processor 115A is not currently executing (e.g., currently stopped), task management module 114 may execute task processor 115A.

Task management module 114 may establish a connection between client 119A and task processor 115A, such that client 119A may receive the semantic output of task processor 115A or otherwise communicate with task processor 115A through such a connection. For example, task management module 114 may establish the connection using shared memory, message passing, or other techniques for interprocess communication.

In response to determining task processor 115A is currently executing, rather than executing task processor 115A again (e.g., executing another copy of task processor 115A), task management module 114 may establish a connection between client 119A and task processor 115A to allow client 119A to receive the semantic output of task processor 115A, such as described above. For example, task processor 115A may be currently executing because task management module 114 previously executed (e.g., started) task processor 115A, such as in response to a previous request for semantic output. For instance, task management module 114 may have previously executed task processor 115A in response to a request for semantic output from client 119B. For example, client 119A and client 119B, may both utilize (e.g., share) the semantic output generated by task processor 115A to obtain a semantic understanding of a scene. In this manner, an individual one of task processors 115 may be shared between a plurality of clients 119.

By sharing task processors 115 between multiple clients 119, task management module 114 reduces utilization of computing resources (e.g., processing resources, memory resources) that would otherwise be consumed in executing multiple versions of one or more of task processors 115. For example, rather than executing a first and second copy of task processor 115A to support the operation of client 119A and client 119B (or one or more other clients 119), computing device may execute a single copy of task processor 115A to support the operation of client 119A and client 119B (or one or more other clients 119). These reductions in computing resource computing resource consumption and thereby improve the operation of computing device 110. For example, the reduced computing resource consumption allows computing device 110 to execute additional task processors 115 and/or clients 119 for given hardware specification (e.g., processor speed, memory capacity) of computing device 110. The reduction in computing resource consumption may also or alternatively improve the performance of computing device 110 in that, by executing task processor 115A rather than multiple of task processors 115, processing load, memory consumption, or other computing resource consumption may be reduced, thereby improving the responsiveness, latency, or other performance characteristic of computing device 110.

Task management module 114 may maintain a record, such as in the form of a registry, of one or more characteristics of respective task processors 115 at (e.g., installed to) client device 110. For example, task management module 114 may store, to the registry, one or more characteristics for task processor 115A including an indication of the semantic output provided by task processor 115A, an indication of whether the semantic output provided by task processor 115A is filterable, an indication of whether task processor 115A is currently executing at computing device 110, and an indication of the type of input (e.g., imaging data, proximity data, location data, acceleration data) task processor 115A uses, or various subsets thereof. In addition or instead of the foregoing characteristics, the one or more characteristics may include one or more attributes, parameters, or other characteristics corresponding to one or more of task processors 115.

Task management module 114 may use the registry to manage machine learning perception tasks. For example, in response to a request for semantic output from a client of clients 119, task management module 114 may query the registry to determine which of task processors 115 provides semantic output corresponding (e.g., matching) the request. To illustrate, task management module 114 may record, to the registry, an indication that task processor 115A provides semantic output identifying objects 124 in the form of traffic lanes, and an indication that task processor 115B provides semantic output identifying objects 124 in the form of rain relative to a windshield or window of vehicle 120, such as to trigger activation of a windshield wiper of vehicle 120. As such, in response to a request from client 119A requesting semantic output that identifies traffic lanes, task management module 114 may determine, based on the information stored to the registry, that task processor 115A provides semantic output corresponding to the request. In response to a request from client 119A (or another of clients 119) requesting semantic output that identifies rain, task management module 114 may determine, based on the information in the registry, that task processor 115B provides corresponding semantic output.

In addition or instead of the indication of the semantic output provided by a task processor of task processors 115, task management module 114 may use one or more other characteristics stored to the registry to determine which of task processors 115 matches a request from a client of clients 119. For example, client 119A may require particular latency criteria which dictate a latency threshold (e.g., 5 milliseconds, 1 second, 5 seconds) that client 119A requires to properly function. For instance, client 119A may provide driver assistance in the form of parking assistance and therefore require a low latency when vehicle 120 arrives at an open parking spot. As such, task management module 114 may query the registry for a task processor of task processors 115 that provides semantic output corresponding to parking assistance (e.g., object detection) and that is capable of meeting the latency criteria of client 119A. For example, task management module 114 may determine task processor 115A meets the latency criteria when task processor 115A has a task prioritization capability that satisfies the latency threshold requested by client 119A. The task prioritization capability of task processor 115A may be expressed (e.g., stored) in the registry numerically (e.g., 5 milliseconds, 1 second, 5 seconds) and/or by indicating the task prioritization capability of task processor 115A. For example, task processor 115A may be capable of different task prioritizations such as low priority (e.g., background prioritization, non-real time), medium priority (e.g., best effort prioritization, non-real time), high priority (e.g., real time, foreground or priority prioritization).

Task management module 114 may maintain, in the registry, a record of which of task processors 115 are currently executing. For example, task management module 114 may store, to the registry, an indication of whether a task processor of task processors 115 is currently executing at computing device 110. For example, task management module 114 may store an indication that task processor 115A is currently executing and an indication that task processor 115B is not currently executing. In response to a request for semantic output, task management module 114 may query the registry to determine whether a task processor of task processors 115 is currently executing. Task management module 114 may execute or refrain from executing the task processor based on whether the task processor is currently executing.

Continuing the above example for instance, in response to determining task processor 115A provides semantic output responsive to the request for semantic output from client 119A, task management module 114 may determine, based on information stored to the registry, whether task processor 115A is currently executing. Assuming task management module 114 determines task processor 115A is currently executing, rather than executing another copy of task processor 115A, task management module 114 may establish a connection between task processor 115A and client 119A. As another example, in response to task processor 114 determining task processor 115B provides semantic output responsive to the request for semantic output from client 119A, task management module 114 may determine, based on information stored to the registry, whether task processor 115B is currently executing. Assuming task management module 114 determines task processor 115B is not currently executing, task management module 114 may accordingly execute task processor 115B and establish a connection between task processor 115B and client 119A.

Task management module 114 may execute task processors 115 such that task processors 115 execute independently (e.g., in isolation). In this manner, instability in one of task processors 115 may not affect operation of another of task processors 115. For example, a crash, error, or other instability at task processor 115A will not affect the operation of task processor 115B. Task processors 115 may change their respective task prioritization during execution. For example, one or more of clients 119 may send messages (e.g., throttle hints) to the task processor corresponding to different task priorities (e.g., low priority, medium priority, high priority) the task processor is capable of and the task processor may accordingly adjust its task prioritization. Task processors 115 may increase their computing resource consumption to achieve a higher task prioritization and lower their computing resource consumption to achieve a lower task prioritization. When lower priority task processors 115 lower their computing resource consumption, higher priority task processors 115 may utilize additional computing resources, such as to improve responsiveness, latency, or other performance metrics. To illustrate, task processor 115A may provide, to client 119A and client 119B, semantic output identifying parking spots. Client 119A may use the semantic output to update a mapping service with empty parking spots recognized by task processor 115A. Client 119B may use the semantic output to provide driver assistance in the form of parking assistance. As such, task processor 115A may operate at a low priority to service client 119A, client 119B, or both until vehicle 120 arrives at a parking spot. At the parking spot, client 119B may cause task processor 115A to execute at a high priority, such as by sending a throttle hint to task processor 115A. In this manner, task processor 115A may provide real time or near real time semantic output to client 119B such that client 119B can provide low latency parking assistance to a user when parking vehicle 120.

Operating system 112 may manage one or more hardware devices, including sensors 122, such as to allow task management module 114, task processors 115, and clients 119, or various subsets thereof to access, use, communicate with (e.g., receive sensor data from and/or transmit commands to), share use of, control, configure, or otherwise operate the one or more hardware devices. Operating system 112 may include one or more modules 117A-117N (collectively, “modules 117A”) to operate such hardware devices. For example, one or more of modules 117 may include or represent one or more device drivers or the like that provide an interface (e.g., application programming interface (API)) to operate one or more of sensors 122 or other hardware devices (e.g., communication units, processors, accelerators). In this manner, another element of computing device 110, such as task management module 114, task processors 115, clients 119, or one or more other software and/or hardware elements may operate (e.g., access, use, communicate with, share use of, control, configure) sensors 122 or other hardware devices through one or more of modules 117.

In the example of FIG. 1, operating system 112 includes sensor module 117A and camera module 117B for operating one or more sensing devices, such as one or more of sensors 122. In general, camera module 117B may allow imaging sensors (e.g., cameras) of sensors 122 to be operated and sensor module 117A may allow other types of sensors 122 (e.g., LIDAR, RADAR, GNSS) to be operated. For example, sensor module 117A may allow one or more of task processors 115 to operate sensor 122A (e.g., LIDAR sensor) and camera module 117B may allow one or more of task processors 115 to operate a sensor 122B (e.g., camera). For instance, sensor module 117A may control (e.g., activate, deactivate) sensor 122A based on input from task processor 115A and/or communicate sensor data collected by sensor 122A to task processor 115A. Similarly, camera module 117A may control sensor 122B based on input from task processor 115A and/or communicate sensor data collected by sensor 122B to task processor 115A. As can be seen, modules 117 may control sensors 122 or other hardware devices based on input (e.g., commands, instructions) received from task processors 115, such as to activate (e.g., turn on), deactivate (e.g., turn off), access (e.g., receive) sensor data, move (e.g., rotate), zoom, or control other functionality sensors 122 provide. In some examples, sensor module 117A may include functionality of camera module 117B such that sensor module 117A may allow operation of additional types of sensors, such as imaging sensors. In such a case, though shown in FIG. 1, camera module 117B may be optional.

As described above, one or more of modules 117 may allow operation of other hardware devices aside from sensors 122. For example, compute module 117C may allow task processors to operate (e.g., access, use, communicate with, share use of, control, configure) one or more compute resources that are available at computing device 110, such as one or more processors or processing units (e.g., central processing units (CPUs), graphics processing units (GPUs), neural processing units (NPUs), artificial intelligence (AI) or other accelerators, or processing cores thereof). For instance, compute module 117C may provide access to one or more processor cores, AI accelerators, or the like to task processors 115, such as to allow task processors 115 to use corresponding compute resources to perform ML tasks (inferencing, classification) or other tasks. Task management module 114 may automatically provide task processors 115 with computing resources, such as to accelerate one or more functions thereof, through computing module 117C.

In some examples, one or more of modules 117 may provide software services at operating system 112. As shown in FIG. 1 for example, security module 117N may provide security services within operating system 112. Security module 117N may monitor operation of operating system 112, clients 119, task processors 115, and other elements of computing device 110, such as to detect and/or mitigate threats (e.g., malware, viruses). As will be described further below, computing device 110 may execute task processors 115, clients 119, or both received from a variety of sources (e.g., different application developers). As such, security module 117N may be advantageous in detecting elements that may constitute threats to the normal or intended operation of computing device 110 or to the user of computing device 110. In response to detecting a threat, security module 117N may disable the corresponding element (e.g., terminate execution of one or more of task processors 115 and/or clients 119 corresponding to the threat). Security module 117N may execute one or more heuristics and/or ML models to analyze task processors 115, clients 119, or both and/or behaviors thereof to detect threats.

Computing system 104 may be any suitable computing device or system, such as one or more desktop computers, laptop computers, mainframes, servers, cloud computing systems, virtual machines, etc. capable of sending and receiving information via network 102. In some examples, computing system 104 may represent a cloud computing system that provides one or more services via network 102. That is, in some examples, computing system 104 may be a distributed computing system. One or more computing devices, such as computing device 110, may access cloud or other services by communicating with computing system 104.

Network 102 may represent any public or private communications network, for instance, cellular, WI-FI, and/or other types of networks, for transmitting data between computing systems, servers, and computing devices. Network 102 may include one or more network hubs, network switches, network routers, or any other network equipment, that are operatively inter-coupled thereby providing for the exchange of information between computing device 110 and computing system 104. Computing device 110 and computing system 104 may transmit and receive data across network 102 using any suitable communication techniques. Each of computing device 110 and computing system 104 may be operatively coupled to network 102 using respective network links, such as Ethernet, WI-FI, cellular, or any other types of wired and/or wireless network connections.

In some examples, computing system 104 includes one or more processors, one or more communication devices, and one or more memory devices. A memory device of computing system 104 may include an operating system, which may provide an execution environment for a distribution module 106 that, when executed by one or more processors, provides download services such as to distribute task processors 115 and/or clients 119 to computing device 110. A memory device of computing system 104 may include a data store 108 that stores various data, such as in a structured or unstructured format. As shown in FIG. 1 for example, data store 108 may represent a database, file folder, or the like that stores task processor packages 103A-103N (collectively, “task processor packages 103”), application packages 105A-105N (collectively, “application packages 105”), or both. Task processor packages 103 may each include or represent a respective task processor of task processors 115. Application packages 105 may each include or represent a respective client of clients 119.

Distribution module 106 may provide distribution services that allow task processor packages 103, application packages 105, or both to be published, discovered, downloaded, and/or installed to one or more computing devices, such as computing device 110. For example, distribution module 106 may provide application store, file server, hypertext transfer protocol (HTTP), file transfer protocol (FTP), or other distribution services suitable for distributing task processor packages 103, application packages 105, or both to computing device 110. Distribution module 106 may receive task processors 115 developed by one or more application developers and store task processors 115 to data store 108, such as in the form of task processor packages 103. Distribution module 106 may receive clients 119 developed by one or more application developers and store clients 119 to data store 108, such as in the form of application packages 105. Application developers may browse task processor packages 103 to identify task processors 115 that may be useful in development of clients 119 and use such task processors 115 in clients 119. For example, an application developer of client 119N may use a task processor of task processors 115 that performs object recognition to allow client 119N to respond to or otherwise use a semantic understanding of traffic incidents (e.g., road closure versus accident) determined based on the semantic output of the task processor. As another example, an application developer of an original equipment manufacturer (OEM) may develop client 119N to perform driver monitoring (e.g., monitoring for driver attentiveness) based on semantic output from a task processor of task processors 115 that indicates driver attentiveness (e.g., alertness, sleepiness, distraction).

Distribution module 106 may generate, for presentation at computing device 110, one or more user interfaces including indications of task processors packages 103, application packages 105, or both that are available for download through computing system 104. Distribution module 106 may receive, from one or more computing devices, such as computing device 110, a selection of one or more of these task processors 115 and, in response, send task processors 115 corresponding to the selection to the corresponding computing devices.

For example, distribution module 106 may receive a selection of application package 105A from computing device 110, such as through an application store, file server, or other user interface that presents, at computing device 110, indications of application packages 105 available for download through computing system 104. In response, distribution module 106 may send application package 105A to computing device 110. Assuming for this example that application package 105A includes client 119A, computing device 110 may install client 119A from application package 105A, such as to a memory or other storage device of computing device 110. Similarly, distribution module 106 may receive a selection of task processor package 103A from computing device 110, such as through an application store, file server, or other user interface that presents, at computing device 110, indications of task processor packages 103 available for download through computing system 104. In response, distribution module 106 may send task processor package 103A to computing device 110. Assuming for this example that task processor package 103A includes task processor 115A, computing device 110 may install task processor 115A from task processor package 103A, such as to a memory or other storage device of computing device 110.

Computing system 104 may send task processor packages 103 to computing device 110 based on clients 119 installed at computing device 110. For example, computing system 104 may automatically send, to computing device 110, each of task processor packages 103 that includes a task processor of task processors 115 that clients 119 at computing device 110 require to function. In this manner, computing system 104 ensures computing device 110 includes task processors 115 required by clients 119 installed at computing device 110. Computing system 104 may send task processor packages 103 including updates to task processors 115 (e.g., new versions of task processors 115) contained therein to computing device 110, such as to update task processors 115 used by clients 119 at computing device 110. Computing device 110 may install and/or update task processors 115 after receiving corresponding task processor packages 115 from computing system 104.

As such, computing device 110 may include task processors 115 from various application developers and clients 119 from the same or different application developers. A client of clients 119 may rely upon a different set of one or more of task processors 115 to provide the respective functionality of the client. For example, client 119A may rely at least upon task processor 115A, client 119B may rely at least upon task processor 115B, client 119C may rely at least upon task processor 115C, and so on and so forth. As described above, one or more of clients 119 may rely on the same task processor of task processors 115. Continuing the above example for instance, various combinations of client 119A, client 119B, and client 119C may additionally rely upon task processor 115N.

In some examples, task management module 114, task processors 115, and sensor modules 117, or various subsets thereof may be part of a subsystem 116 of operating system 112. Elements of subsystem 116 may be separate from other elements of operating system 112. For example, elements of subsystem 116, such as task management module 114, task processors 115, and sensor modules 117, or various subsets may represent integral parts of operating system 112 which may included by a provider of operating system 112 and clients 119 may represent elements installed to computing device 110, such as through operating system 112. In some examples, clients 119 may be provided an application developer of the manufacturer (e.g., OEM) of vehicle 120.

Vehicle 120 may be an example of a car, truck, boat, aircraft, train, bicycle, motorcycle, scooter, skateboard, or any other type of motorized or non-motorized vehicle. Regardless of the type of vehicle, vehicle 120 may represent a software defined vehicle that utilizes software to control at least some of its operation. FIG. 1 illustrates a particular example of vehicle 120, and many other examples of vehicle 120 may be used in other instances which may include a subset of the components included in vehicle 120 or may include additional components not shown in FIG. 1. Vehicle 120 may include one or more components that provide various functions or features of vehicle 120. Examples of these components may include devices such as actuators, motors, and electronic systems. In some examples, these components may include door locks, ignition systems, steering systems, braking systems, propulsion systems, transmission systems (e.g., automatic or manual transmissions), infotainment systems, and door/window actuation systems (e.g., door/window motors). One or more of clients 119 may control various elements of vehicle 120, such as based on semantic output from one or more of task processors 115.

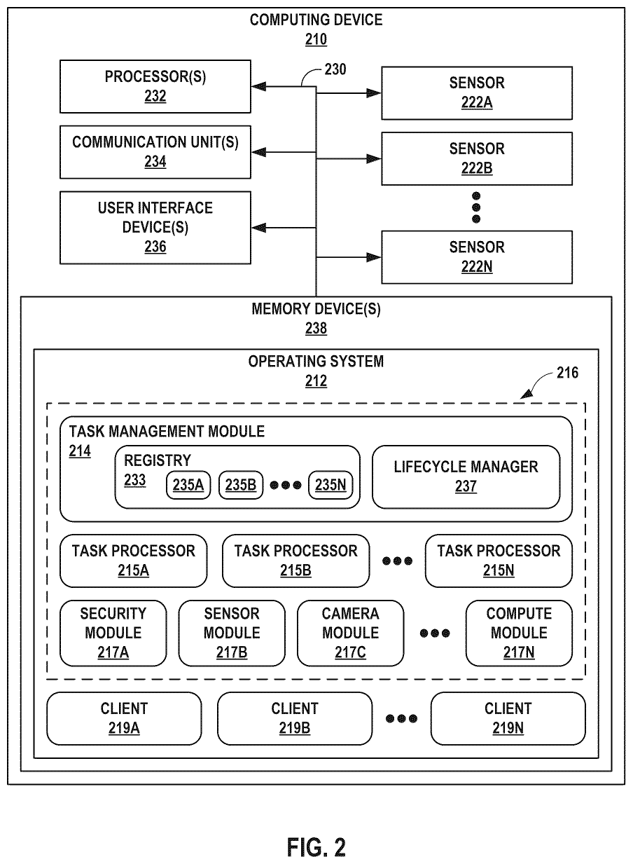

FIG. 2 is a block diagram illustrating an example computing device, in accordance with one or more aspects of the present disclosure. As can be seen, computing device 210 may include one or more processors 232, one or more communication units 234, one or more user interface devices 236, one or more sensors 222A-222N (collectively, sensors 222), and one or more memory devices 238, or various subsets thereof. Aspects of FIG. 2 may be described in the context of FIG. 1. For example, computing device 210, sensors 222, and operating system 212 may respectively be examples of computing device 110, sensors 122, and operating system 112 of FIG. 1. FIG. 2 illustrates a particular example of computing device 210, and many other examples of computing device 210 may be used in other instances and may include a subset of the components included in example computing device 210 or may include additional components not shown in FIG. 2.

One or more memory devices 238 of computing device 210 may include operating system 212 and task management module 214. Operating system 212 and task management module 214 may respectively be examples of operating system 112 and task management module 114 of FIG. 1. One or more memory devices 238 may include one or more task processors 215A-215N (collectively, “task processors 215”), one or more modules 217A-217N (collectively, “modules 217”), and one or more clients 219A-219N (collectively, “clients 219”), which may respectively be examples of task management module 114, task processors 115, modules 117, and clients 119 of FIG. 1. Similarly, subsystem 216 of FIG. 2 may be an example of subsystem 116 of FIG. 1.

One or more communication channels 230 may interconnect each of the components 222, 232, 234, 236, 238 for inter-component communications (physically, communicatively, and/or operatively). In some examples, one or more communication channels 230 may include a system bus, a network connection, an inter-process communication data structure, or any other method for communicating data.

User interface device 236 of computing device 210 may represent hardware that functions as an input and/or output device for computing device 210. For example, user interface device 236 may include a display component, which may be a screen at which information is displayed by user interface device 236 and a presence-sensitive input device that may detect an object at and/or near the display component. In some examples, user interface device 236 may include one or more input devices that receive input. Examples of input include tactile, audio, and video input. Input devices of user interface device 236, in one example, includes a presence-sensitive display, touch-sensitive screen, mouse, keyboard, voice responsive system, video camera, microphone or any other type of device for detecting input from a human or machine. User interface device 236 may include one or more output devices that generate output. Examples of output include tactile, audio, and video output. Output devices user interface device 236, in one example, includes a presence-sensitive display, sound card, video graphics adapter card, speaker, liquid crystal display (LCD), organic light-emitting diode (OLED) display, a light field display, haptic motors, linear actuating devices, or any other type of device for generating output to a human or machine.

One or more communication units 234 of computing device 210 may communicate with external devices by transmitting and/or receiving communication signals, such as via one or more wireless networks or wireless connections. Examples of one or more communication units 234 include a network interface card, an optical transceiver, a radio frequency transceiver, a global positioning system (GPS) receiver, or any other type of device that can wirelessly send and/or receive information. Other examples of one or more communication units 234 may include short wave radios, cellular data radios, wireless network radios, as well as universal serial bus (USB) controllers. Computing device 110 may include one or more communication units 234 that use wired connections, such as network interface cards (e.g., Ethernet cards), fiberoptic transceivers, or any other type of device that can send and/or receive information over a wired connection.

One or more processors 232 may implement functionality and/or execute instructions within computing device 210. For example, one or more processors 232 on computing device 210 may receive and execute instructions stored by one or more memory devices 238 that execute the functionality of operating system 212 and task management module 214. The instructions executed by one or more processors 232 may cause computing device 210 to store information within one or more memory devices 238 during program execution. Examples of one or more processors 232 include general purpose processors (e.g., central processing units (CPUs), accelerators (e.g., graphics processing units (GPUs), neural processing units (NPUs), application processors, display controllers, sensor hubs, and any other hardware configured to function as a processing unit. One or more processors 232 may execute instructions of operating system 212, task management module 214, task processors 215, modules 217, and clients 219, or various subsets thereof to perform actions or functions. That is, one or more of operating system 212, task management module 214, task processors 215, modules 217, or clients 219 may be operable by one or more processors 232 to perform various actions or functions of computing device 210.

One or more memory devices 238 within computing device 210 may store information for processing during operation of computing device 210. That is, computing device 210 may store data accessed by operating system 212, task management module 214, task processors 215, modules 217, and/or clients 219 during execution at computing device 210, including registry 233 and other data.

In some examples, memory devices 238 may be temporary memory, meaning that a primary purpose of memory device 238 is not long-term storage. One or more memory devices 238 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

One or more memory devices 238, in some examples, also include one or more computer-readable storage media. One or more memory devices 238 may be configured to store larger amounts of information than volatile memory. One or more memory devices 238 may further be configured for long-term storage of information as non-volatile memory space and retain information after power on/off cycles. Examples of non-volatile memories include magnetic hard discs, optical discs, flash memories, or forms of electrically programmable memories (EPROM) or electrically erasable and programmable (EEPROM) memories. One or more memory devices 238 may store program instructions and/or information (e.g., data) associated with operating system 212 and task management module 214.

Task management module 214 may execute at one or more processors 232 to perform management of machine learning perception tasks. Task management module 214 may include registry 233 and lifecycle manager 237. Examples of registry 233 include files (e.g., comma separated value (CSV) files, JavaScript object notation (JSON) files, software query language (SQL) databases, not only SQL (NoSQL) databases, and other structured or unstructured data formats. For example, registry 233 may represent a database that stores registry information in one or more entries 235A-235N (collectively, “entries 235”). Entries 235 may represent rows or other units of data in registry 233. One or more of entries 235 may store information about a respective task processor of task processors 215A.

For example, task management module 214 may maintain (e.g., store, update), such as in one or more of entries 235 of registry 233, a record of one or more characteristics of respective task processors 215 at (e.g., installed to) computing device 210. As described above, examples of such characteristics include an indication of the semantic output provided by a task processor of task processors 215, an indication of whether the semantic output provided by the task processor is filterable, an indication of whether the task processor is currently executing at computing device 310, an indication of the type of input (e.g., imaging data, proximity data, location data, acceleration data) the task processor uses, or various subsets thereof.

Task management module 214 may store characteristics of individual task processors 215 in respective entries 235 of registry 233. For example, task management module 214 may store one or more characteristics of a first task processor 215A to entry 235A, one or more characteristics of a second task processor 215B to entry 235B, and one or more characteristics of an nth task processor 215N to entry 235N. Task management module 214 may determine the one or more characteristics from metadata or other data included or otherwise provided with task processors 215. For example, task management module 214 may determine the type of semantic output provided by task processor 215A based on metadata included with task processor 215A that provides an indication of the type of semantic output provided by task processor 215A and/or an indication of the type of input used by task processor 215A, such as in a file or other data of task processor 215A. In some examples, such metadata may be included in a task processor package including task processor 215A.

Table 1 below provides an example of registry 233. In the example of Table 1, each row may correspond to an entry of entries 235. For example, the first row of Table 1 may correspond to entry 235A, the second row of Table 1 may correspond to entry 235B, and the third row of Table 1 may correspond to entry 235N. As such, entry 235A may include one or more characteristics of task processor 215A, entry 235B may include one or more characteristics of task processor 215B, and entry 235N may include one or more characteristics of task processor 215N relative to the example of Table 1. Aside from the “Task Processor” column which identifies a respective task processor of task processors 215, each column of Table 1 may include one or more characteristics of the respective task processor.

TABLE 1

| Task | Input | Output | | Currently |
|---|---|---|---|---|
| Processor | Type | Type | Filterable | Executing |
| 215A | Imaging Data | Objects | Yes | Yes |
| 215B | Imaging Data, | Pose | No | Yes |
| | Proximity Data | | | |
| 215N | Location Data | Location | No | No |

As can be seen, for each of task processors 215, registry 233 may indicate the input type, output type, whether the output is filterable and/or whether each task processor is currently executing. The input type characteristic may be an indication of the type of data the respective task processor of task processors 215 may use as input and/or the source of the input data. For example, imaging data may correspond to visual data (e.g., images, photos, video) captured by an imaging sensor of sensors 222, proximity data may correspond to range information (e.g., distance, relative location) captured by a range sensor of sensors 222, and location data may correspond to location data (e.g., latitude, longitude) captured by a location sensor of sensors 222. As can be seen, registry 233 may indicate multiple input types for one or more of task processors 215. As shown in the example of Table 1 for instance, task processor 215B uses input including both imaging data and proximity data.

In some examples, one or more of modules 217 may route sensor data from sensors 222 to one or more of task processors 215 based on the input type of the one or more task processors. For example, camera module 217C may send sensor data (e.g., imaging data) from an imaging sensor of sensors 222 to task processor 215A and task processor 215B. As another example, sensor module 217B may send sensor data (e.g., proximity data, location data) from one or more range, proximity, or location sensors of sensors 222 to task processor 215B and/or task processor 215N.

The output type may be an indication of the semantic output provided (e.g., generated) by a task processor of task processors 215. Continuing the example of Table 1, task processor 215A may generate semantic output in the form of objects recognized from the imaging data task processor 215A receives as input. For instance, task processor 215A may generate semantic output that labels or otherwise identifies objects task processor 215A identifies from the imaging data. Task processor 215A may generate semantic output that identifies such objects by name (e.g., fire hydrant, lane, sign). Similarly, task processor 215B may generate semantic output in the form of a pose for objects recognized from the imaging data and/or proximity data task processor 215B receives as input. For example, task processor 215B may generate semantic output that identifies a position (e.g., coordinates) for such objects. For instance, task processor 215B may generate semantic output that identifies a latitude, longitude, and altitude of objects task processor 215B recognizes from the imaging data and/or proximity data.

Registry 233 may also include indications of whether the semantic output provided by task processors 215 is filterable. Continuing the above example, the semantic output of task processor 215A, which identifies objects recognized from the imaging data, may be filterable such as to limit the semantic output to a particular subset of the semantic output. For instance, client 219A may only use semantic output identifying a particular set of objects (e.g., lane, sign) from the overall set of objects (e.g., fire hydrant, lane, sign) task processor 215A may recognize. Client 219A may request that task management module 214, task processor 215A, or both filter the semantic output to limit the semantic output to a subset of output desired by client 219A. In response, task management module 214, task processor 215A, or both may filter the semantic output of task processor 215A such that only the requested subset of semantic output is provided (e.g., sent) to client 219A.

Task management module 214 may maintain (e.g., store, update), such as in one or more of entries 235 of registry 233, a record of which of task processors 215 are currently executing. For example, task management module 214 may store, to one or more of entries 235 for a task processor of task processors 215, an indication of whether the task processor is currently executing at computing device 210. In some examples, task management module 214 may determine whether the task processor is currently executing by communicating with operating system 212. For example, task management module 214 may send an API or other request, command, or other message to operating system 212 requesting the execution status (e.g., currently executing, not currently executing) of one or more of task processors 215. For instance, task management module 214 may determine task processor 215A is currently executing when operating system 212 indicates a thread or other process assigned to or that otherwise implements task processor 215A is currently running and determine task processor 215A is not currently executing when operating system 212 indicates such thread or other process is not currently executing.

Task management module 214 may store and/or update the one or more characteristics of respective task processors 215 at registry 233 at various times. For example, task management module 214 may store and/or update, at registry 233, one or more characteristics of a task processor of task processors 215 when the task processor is installed to computing device 210, when the task processor is downloaded, and/or when the task processor is updated. As another example, task management module 214 may store and/or update, at registry 233, one or more characteristics, such as one or more indications of whether the task processor is currently executing, periodically, in response to the task processor being executed or terminated, or in response to a request for semantic output from one or more of clients 219.

Task management module 214 may manage task processors 215 using registry 233. For example, task management module 214 may execute or refrain from executing task processors 215 based on information stored to registry 233. For instance, task management module 214 may receive a request for semantic output from client 219A. In response to the request for semantic output from client 219A, task management module 214 may access registry 233 to determine which of task processors 215 provides semantic output corresponding (e.g., matching) the request. For example, task management module 214 may query registry 233 to determine which of task processors 215 provides the corresponding semantic output. For instance, client 219A may send, to task management module 214, a request for semantic output requesting semantic output that identifies objects which, in the example of Table 1, corresponds to the output type of “Objects.” In response, task management module 214 may query registry 233 for a task processor of task processors 215 that provides semantic output in the form of objects. As such, with respect to the example of Table 1, registry 233 may return an indication of task processor 215A to task management module 214 in response to the query.

In response to determining a task processor of task processors 215 provides semantic output responsive to the request for semantic output from one or more of clients 219, task management module 214 may determine whether the task processor is currently executing. Task management module 214 may execute or refrain from executing the task processor based on whether the task processor is currently executing. Continuing the above example for instance, task management module 214 may query registry 233 to determine whether task processor 215A is currently executing. If task management module 214 determines, from registry 233, task processor 215A is currently executing, rather than executing another copy of task processor 215A, task management module 214 may establish a connection between task processor 215A and client 219A. If task management module 214 determines task processor 215A is not currently executing, task management module 214 may accordingly execute task processor 215A and establish a connection between task processor 215A and client 219A.

Task management module 214 may establish a connection between a task processor of task processors 215 and one or more of clients 119 in various ways. For example, task management module 214 may establish such a connection using shared memory, message passing, or other techniques for interprocess communication between one or more of task processors 215 and one or more of clients 219. For instance, task management module 214 may provide a pipe handle, file handle, or the like assigned to task processor 215A to client 219A to establish a connection through which task processor 215A and client 219A may communicate. Client 219A may receive semantic output from task processor 215A and/or otherwise communicate with task processor 215A through the connection.

Task management module 214 may include lifecycle manager 237. Lifecycle manager 237 may manage the lifecycles of task processors 215, such as by controlling the execution and/or termination of task processors 215. For example, task management module 214 may execute a task processor of task processors through lifecycle manager 237, such as in response to a request for semantic output from one or more of clients 119. Lifecycle manager 237 may monitor the usage of the task processor by one or more of clients 119 to determine whether the task processor is in use. In response to determining the task processor is not in use, lifecycle manager 237 may terminate execution of the task processor. For example, lifecycle manager 237 may determine task processor 215A is not in use when client 219A is closed (e.g., terminated), when client 219A has not received communication (e.g., semantic output) from task processor 215A for at least a threshold time period (e.g., 1 minute, 5 minutes, 10 minutes), or both.

Lifecycle manager 237 may record, such as to one or more of entries 235 of registry 233, an indication of whether respective task processors 215 are in use, such as shown in Table 2 below. Such indication may be another example of the one or more characteristics of task processors 215 that task management module 214 may manage (e.g., store, update) in registry 233. As can be seen from the example of Table 2, registry 233 may include an indication of whether each of task processors 215 in registry 233 is in use or not. For instance, registry 233 in the example of Table 2 shows task processor 215A is in use by client 119A and client 119N, task processor 215B is in use by client 119B, and task processor 215N is not in use. As such, lifecycle manager 237 may determine task processor 215A and task processor 215B are in use and task processor 215N is not in use. In response to determining task processor 215N is not in use, lifecycle manager 237 may terminate execution of task processor 215N. In some examples, lifecycle manager 237 may determine whether task processor 215N is currently executing and refrain from determining whether task processor 215N is in use when task processor 215N is not currently executing.

TABLE 2

| Task | Input | Output | Currently | |
|---|---|---|---|---|
| Processor | Type | Type | Executing | In Use |
| 215A | Imaging Data | Objects | Yes | Client 119A, |
| | | | | Client 119N |
| 215B | Imaging Data, | Pose | Yes | Client 119B |
| | Proximity Data | | | |
| 215N | Location Data | Location | Yes | No |

As can be seen from the example of Table 2, registry 233 may indicate whether a task processor of task processors 215 is in use by identifying clients 119 that are using the task processor. In some examples, rather than storing indications of clients 119 that are using the task processor, lifecycle manager 237 may maintain (e.g., store, update) a count of clients 119 that are using the task processor. For example, lifecycle manager 237 may increment the count when individual clients of clients 119 start using the task processor, and decrement the count when individual clients of clients 119 stop using the task processor. Lifecycle manager 237 may terminate the task processor when the count indicates no clients 119 are using the task processor (e.g., the count is changed to zero).

Task management module 214 may maintain (e.g., store, update), in registry 233, the indication of whether a task processor of task processors 215 is in use at various times. For example, task management module 214 may store and/or update one or more of entries 235 of registry 233 to indicate whether a task processor of task processors 215 is in use in response to receiving a request for semantic output from one or more of clients 219, when executing the task processor, when establishing a connection between one or more of clients 119 and the task processor, or when the task processor is terminated, such as by lifecycle manager 237.

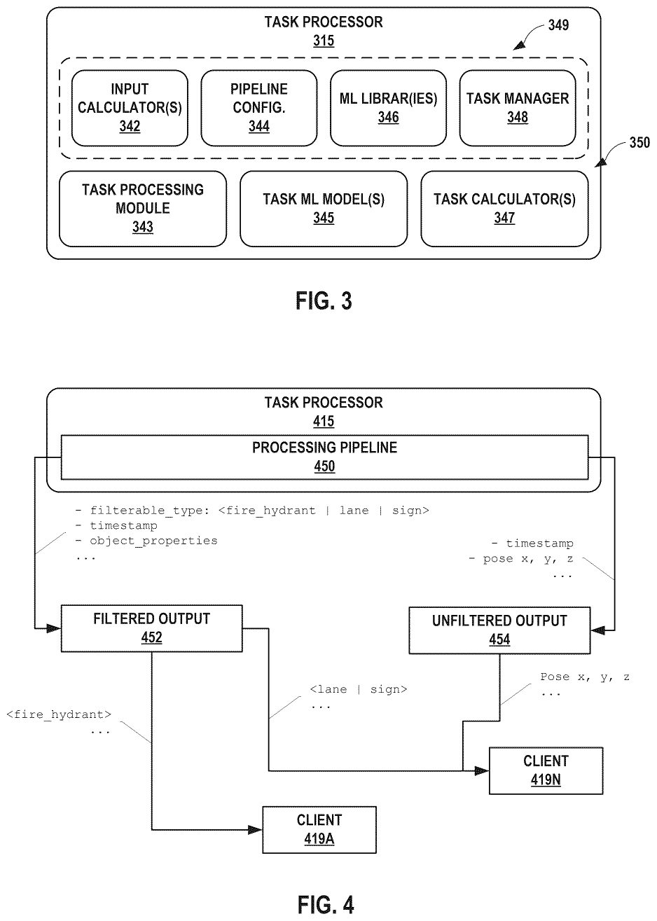

FIG. 3 is a block diagram illustrating an example task processor, in accordance with one or more aspects of the present disclosure. Aspects of FIG. 3 may be described in the context of FIGS. 1-2. For example, task processor 315 may be an example of task processors 115 of FIG. 1.

Task processor 315 may perform one or more ML tasks. As described above for example, task processor 315 may receive sensor data from one or more sensors 122 and generate semantic output describing the one or more aspects of sensor data. Task processor 315 may include framework components 349, one or more of which may be common across (e.g., included in) different task processors 315. For example, an application developer may use framework components 349 to more readily develop task processor 315.

As shown in the example of FIG. 3 for instance, framework components 349 may include one or more input calculators 342, pipeline configuration 344, one or more ML libraries 346, and task manager 348, or various subsets thereof. One or more of framework components 349 may be used by one or more other elements of task processor 315. For example, task processor 315 may include task processing module 343, task ML model 345, and task calculator 347, or various subsets thereof that may use one or more of framework components 349 to generate semantic output. For instance, task processing module 343, task ML model 345, and/or task calculator 347 may be provided by a task processor provider (e.g., application developer) while framework components 349 may be provided by a framework provider (e.g., OEM), such as part of an API and/or framework for managing task processor 315 using task management module 114.

Task processing module 343 may facilitate performance of one or more tasks of task processor 315. For example, task processing module 343 may apply (e.g., executing) one or more of task ML models 345, task calculators 347, or both to perform a task of task processor 315. For instance, task processing module 343 may receive sensor data collected by one or more of sensors 222 as input and apply task ML model 345 to the sensor data to recognize one or more objects represented in the sensor data. Task processing module 343 may generate semantic output based on the output of ML model 345. In this example for instance, task processing module 343 may generate semantic output including labels or other indications that name or otherwise describe the one or more objects recognized by ML model 345.

Task processing module 343 may also generate semantic output based on output of task calculator 347. In general, task calculators 347 may generate intermediary output that may be used by another element of task processor 315 (e.g., task processing module 343, task ML models 345) to generate output. For example, ML model 345 may apply the output of task calculator 347 to generate output which task processing module 343 may use to generate the semantic output. For instance, ML model 345 may be an object recognition ML model that recognizes traffic signs. To illustrate, ML model 345 may apply task calculator 347 to determine whether a speed of vehicle 120 relative to a speed limit posted in one or more traffic signs.

Task processing module 343, task models 345, and task calculators 347, or various subsets thereof may represent a processing pipeline 450, or one or more portions thereof. For example, task processing module 343 may apply one or more of task models 345, one or more of task calculators 347, or both according to a pipeline whereby output of a task model of task models 345 or a task calculator of task calculators 347 may be used as input to another of task models 345 or task calculators 347.

Processing pipeline 450, when executed by task processing module 343, may cause task models 345, task calculators 347, or various subsets thereof to be applied according to particular sequence. For example, processing pipeline 450 may correspond to an interconnected graph with an ordered sequence of one or more of task models 345 or task calculators 347 being applied at nodes of the graph. As such, to execute processing pipeline 450, task processing module 343 may traverse the nodes of the interconnected graph in sequence and, at each traversed node, apply the task processor or task calculator of the node using output from the previously traversed node as input.

Framework components 349 may include helper, utility, or other commonly used functions which may be used by task processing module 343, task ML models 345, and/or task calculators 347. As such, framework components 349 may support the operation of task processing module 343, one or more task ML models 345, and/or one or more task calculators 347. For example, one or more input calculators 342 and one or more ML libraries 346 may represent helper or utility functions that receive an input and generate output for use by task processing module 343, one or more task ML models 345, and/or one or more task calculators 347. One or more ML libraries 346 may provide ML related functionality (e.g., runtime support for task ML models 345, GPU/NPU acceleration for task ML models 345) and one or more input calculators 342 may provide ML or non-ML related functions or features (e.g., math libraries, data transforms, data parsers). For example, task processing module 343 or another element of task processor 315 may use input calculators 342 to format or transform sensor data collected by one or more sensors 222, such as to prepare the sensor data for use by task ML models 345, task calculators 347, or another element of task processor 315. As another example, task processing module 343 or another element of task processor 315 may use input calculators 342 to generate inferences, classifications, or other ML based output from sensor data.

Pipeline configuration 344 may provide configuration information for task processor 315. Pipeline configuration 344 may represent settings, parameters, or other configuration information that may define the operation of one or more elements of task processor 315. For example, pipeline configuration 344 may represent a protocol buffer (protobuf) including settings, parameters, or other configuration information for task processor 315. For instance, pipeline configuration 344 may include configuration information indicating a type and/or format of semantic output provided by task processor 315, whether the semantic output of task processor 315 is filterable and/or categories of the semantic output that may be filtered (e.g., fire hydrants, lanes, signs), one or more latency criteria (e.g., responsiveness) for task processor 315, throttling or task prioritization capabilities (e.g., whether task processor 315 is capable of running at low, medium, or high prioritization) of task processor 315, or other settings or parameters. In some examples, pipeline configuration 344 may represent at least a portion of metadata for task processor 315. As such, task management module 214 may store configuration information to registry 233, such as in one or more of entries 235.

Task manager 348 may manage the operation of task processor 315. For example, task manager 348 may initialize (e.g., load, allocate) and/or de-initialize (e.g., unload, deallocate) memory or other computing resources for task processor 315 or one or more elements thereof, such as to respectively facilitate execution and/or termination of task processor 315. Task manager 348 may receive signals, throttle hints, or other commands, such as from lifecycle manager 237, and cause task processor 315 to execute and/or terminate based on commands. Task manager 348 may communicate status or other messages, such as to lifecycle manager 237 or another element of task management module 214. Task manager 348 may publish output streams including the semantic output of task processor 315 for use by clients 119, such as according to a protocol of pipeline configuration 344, and register callbacks which may provide semantic output from other task processors that task manager 348 may publish to the output stream.

FIG. 4 is a block diagram illustrating a first example of a processing pipeline, in accordance with one or more aspects of the present disclosure. Aspects of FIG. 4 may be described in the context of FIGS. 1-3. For example, task processor 415, processing pipeline 450, and clients 419A-419N (collectively, “clients 419”) may respectively be examples of task processor 315 and processing pipeline 350 of FIG. 3 and clients 219 of FIG. 2.

Task processor 415 may host (e.g., include) processing pipeline 450 and execute processing pipeline 450 to generate semantic output. Task processor 415 may execute processing pipeline 450 to cause functionality of task ML models 345 and task calculators 347, or various subsets thereof to be executed in a particular sequence. In this manner, processing pipeline 450, when executed, may generate the semantic output of task processor 415. Processing pipeline 450 may provide filtered or unfiltered semantic output to various clients 410.

In the example of FIG. 4, filtered output 452 represents filtered semantic output and unfiltered output 454 represents unfiltered semantic output. Filtered output 452 may correspond to a subset of semantic output generated by processing pipeline 450. For example, task processor 415 may perform an object recognition task and generate semantic output that identifies one or more of objects 124 recognized by task processor 415, such as through one or more task ML models 345 and/or task calculators 347 thereof. In the example of FIG. 4, processing pipeline 450 outputs object identifications for fire hydrants, lanes (e.g., traffic lanes), and signs (e.g., traffic signs), which is filterable. Filtered output 452 may filter the semantic output of processing pipeline 450 such as by filtering out (e.g., removing) one or more categories of objects (e.g., fire hydrants), and send the filtered semantic output to clients 419.

Clients 419 may request filtered semantic output and task processor 415, such as through filtered output 452, may provide semantic output filtered according to the request. Clients 419 may include in respective requests an indication of one or more categories to filter out (e.g., exclude) or one or more categories to exclusively include. In the example of FIG. 4 for instance, client 419A has requested a subset of the semantic output of processing pipeline 450 that filters out objects in the categories of lanes and signs and thus only includes objects in the category of fire hydrants. Client 419A, in this example, may be a public safety application or the like that is only interested in mapping fire hydrants. As such, rather than sending indications of fire hydrants, lanes, and/or signs recognized through processing pipeline 450, task processor 415 may only send, to client 419A, indications of fire hydrants recognized through processing pipeline 450. As another example, client 419B has requested a subset of the semantic output of processing pipeline 450 that filters out objects in the category of fire hydrants and thus only includes objects in the categories of lanes or signs. As such, rather than sending indications of fire hydrants, lanes, and/or signs recognized through execution of processing pipeline 450, task processor 415 may only send, to client 419B, indications of lanes or signs recognized through processing pipeline 450. Client 419B, in this example, may be a driver assistance application that provides turn-by-turn navigation and therefore is not interested in fire hydrants.

Task processor 415 may perform one or more tasks. As can be seen from the example of FIG. 4, task processor 415 may additionally or alternatively perform a proximity or other ranging task and generate semantic output identifying a pose of one or more of objects 124. For instance, task processor 415 may send, to client 419N, the semantic output including the pose. Some semantic output, such as poses, may constitute unfiltered output in that such semantic output may not be amenable or otherwise suitable to being filtered. To illustrate, poses may generally be considered atomic in that removal (e.g., filtering) a portion of information (e.g., one or more spatial coordinates) may render poses unusable for their intended purpose (e.g., unsuitable for identifying the position of an object).

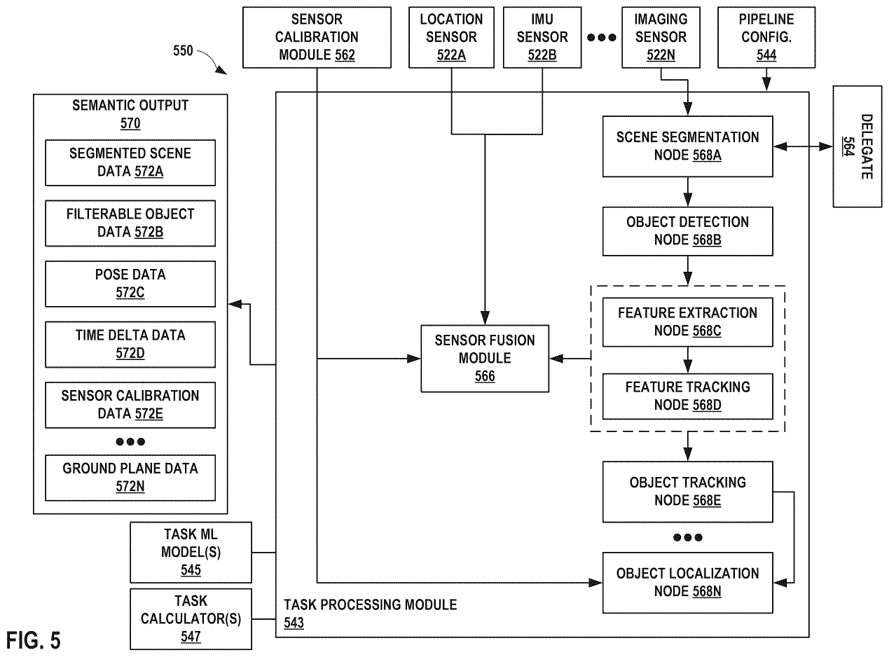

FIG. 5 is a block diagram illustrating a second example of a processing pipeline, in accordance with one or more aspects of the present disclosure. Aspects of FIG. 5 may be described in the context of FIGS. 1-3. For example, task processing module 543, pipeline configuration 544, processing pipeline 550, and sensors 522A-522N (collectively, “sensors 522”) may respectively be examples of task processing module 343, pipeline configuration 344, and processing pipeline 350 of FIG. 3 and sensors 122 of FIG. 1.

Task processing module 543 may represent a graph runner or the like that executes processing pipeline 550. Processing pipeline 550 may represent a graph including one or more sequences of one or more nodes 568A-568N (collectively, “nodes”). As described above, to execute processing pipeline 550, task processing module 543 may traverse the graph and at each traversed node of nodes 568, execute one or more functions assigned to the traversed node. For example, task processing 543 may apply one or more of task ML models 545, task calculators 547, or both when task processing module 543 is at the traversed node (e.g., traverses to the traversed node). Task ML models 545 and task calculators 547 may respectively be examples of task ML models 345 and task calculators 347 of FIG. 3. Task processing module 543 may use output of a previously traversed node of nodes 568, sensor data, and/or other input may as input to the traversed node.

As can be seen from the example of FIG. 5, scene segmentation node 568A may receive input in the form of sensor data collected by imaging sensor 522N. Continuing this example, object detection node 568B may receive input corresponding to the output of scene segmentation node 568A, feature extraction node 568C may receive input corresponding to the output of object detection node 568B, feature tracking node 568D may receive input corresponding to the output of feature extraction node 568C, object tracking node 568E may receive input corresponding to the output of feature tracking node 568D, and object localization node 568N may receive input corresponding to the output of object tracking node 568E. In this manner, nodes 568 form an interconnected graph of processing pipeline 550 whereby task processing module 543 may execute functionality assigned to respective nodes 568 in a sequence whereby output from one node of nodes 568 may be used as input to another node of nodes 568.

As described above, nodes 568 may correspond to one or more functions of task ML models 545, task calculators 547, or both. With respect to the example of FIG. 5, a task ML model of task ML models 545 may be assigned to scene segmentation node 568A such that, at scene segmentation node 568A, task processing module 543 may apply the task ML model to input received at scene segmentation node 568A. In this example, the task ML model may segment or otherwise separate a scene (e.g., image, photo) captured in sensor data collected by imaging sensor 522N into one or more constituent elements. For instance, the task ML model may separate the scene into a background portion, a foreground portion, and/or one or more other segments. As such, when task processing module 543 traverses processing pipeline 550 to scene segmentation node 568A, task processing module 543 may apply the task ML model of scene segmentation node 568A to output an indication of one or more of these segments.

As another example, one or more of task ML models 545, task calculators 547, or both may be assigned to object detection node 568B, feature extraction node 568C, feature tracking node 568D, object tracking node 568E, and object localization node 568N. For instance, a task calculator of task calculators 547 may be assigned to object detection node 568B such that, at object detection node 568B, task processing module 543 may apply the task calculator to input received at object detection node 568B. In this example, the task calculator may perform object detection on input corresponding to the output (e.g., scene segments) of scene segmentation node 568A. For instance, the task calculator may perform object detection (e.g., object recognition) on one or more segments (e.g., a subset of segments) of the scene as determined at scene segmentation node 568A. To illustrate, the task calculator may only perform object detection on a foreground segment of the scene and thereby ignore less relevant objects in a background segment of the scene. Object detection node 568B may output, such as through the task calculator, one or more indications of objects 124 detected from one or more segments of the scene.

Feature extraction node 568C may extract (e.g., identify) features of objects 124 detected at object detection node 568B. For example, at feature extraction node 568C, task processing module 543 may apply a task calculator of task calculators 547 to identify one or more characteristics, attributes, or other features of objects 124. For instance, for an object of objects 124 corresponding to a traffic light, object detection node 568B may extract features such as whether the traffic light is illuminating a green, yellow, or red light. Feature tracking node 568D may track changes (e.g., detect changes) to features extracted at feature extraction node 568C. For example, at feature tracking node 568D, task processing module 543 may apply a task calculator of task calculators 547 to track changes to traffic signals emitted by the traffic light (e.g., changes from green to yellow, yellow to red, red to green lights).

Object tracking node 568E may track changes to objects, such as objects 124 detected at object detection node 568B. For example, at object tracking node 568E, task processing module 543 may apply a task calculator of task calculators 547 that tracks changes to objects 124. For instance, the task processor may track changes in movement (e.g., in motion, stationary) of an object (e.g., pedestrian, other vehicles) of objects 124. In some examples, object tracking node 568E may detect changes to objects 124 based on the output of feature tracking node 568D. For example, object tracking node 568E may output an indication of a change to the object (e.g., traffic signal) when feature tracking node 568D detects a change to a feature of the object.

In some examples, processing pipeline 550 may include a graph that routes output of one or more of nodes 568 to multiple of nodes 568. As shown by the broken line box surrounding feature extraction node 568C and feature tracking node 568D, the output (e.g., features, changes to features) of feature extraction node 568C, feature tracking node 568D, or both may be routed to sensor fusion module 566 as well as to object tracking node 568E. Object localization node 568N may localize objects, such as objects 124 detected at object detection node 568B. For example, at object localization node 568N, task processing module 543 may apply a task calculator of task calculators 547 to determine a pose of an object of objects 124. For instance, the task calculator may determine coordinates identifying the location of the object.

In some examples, a node of nodes 568 may include a delegate 564. Delegate 564 may represent a function that the node may execute, such as to handle one or more events during the execution of the node. For example, task processing module 543 may assign (e.g., register) delegate 564 to one or more of task ML models 545 and/or task calculators 547 of the node. As shown in the example of FIG. 5 for instance, task processing module 543 may register delegate 564 to scene segmentation node 568A. As such, scene segmentation node 568A, such as through a task ML model of task ML models 545 and/or a task calculator of task calculators 547, may execute delegate 564 in response to an event that occurs during execution of scene segmentation node 568A. For example, scene segmentation node 568A may execute delegate 564 to provide status updates to delegate 564. For instance, the task ML model and/or task calculator may execute delegate 564 in response to identifying a scene segment from the sensor data of imaging sensor 522N. Delegate 564 may perform a helper, utility, or other function, such as storing identified segments in one or more data structures, notifying other elements of task management module 114 or computing device 110 of status changes, and the like.

Sensor fusion module 566 may combine sensor data and other data from various sources to perform sensor fusion, such as to estimate one or more characteristics, attributes, or other features of objects, such as one or more of objects 124. For example, sensor fusion module 566 may perform visual inertial odometry to estimate the change in position of an object of objects 124 over time. As can be seen from the example of FIG. 5, sensor fusion module 566 may use output from one or more of sensors 522, such as location sensor 522A and/or IMU sensor 522B, and/or output from one or more of nodes 568, such as feature extraction node 568C and/or feature tracking node 568D, to perform sensor fusion. For example, location sensor 522A and/or IMU sensor 522B may generate sensor data indicating a location and speed of vehicle 120 and feature extraction node 568C and/or feature tracking node 568D may generate output indicating a relative position or relative speed of an object of objects 124. For example, based on wheel rotation indicated by feature extraction node 568C and/or feature tracking node 568D and sensor data from location sensor 522A and/or IMU sensor 522B, sensor fusion module 566 may generate output indicating whether the object is moving relative to vehicle 120, an estimated velocity of the vehicle, an estimated heading (e.g., north, south, east, west) of the object, or the like. In addition to using the output of other nodes of nodes 568 as input, one or more of nodes 568 may use the output of sensor fusion module 566 as input. For example, object localization node 568N may use the output of sensor fusion module 566 and the output at object tracking node 568E as input, such as to determine the position of an object of objects 124 over time.

Task processing module 543 may generate semantic output 570 by executing processing pipeline 550. For example, task processing module 543 may generate semantic output 570 based on the output of one or more of nodes 568, such as a last or other node in a sequence of nodes 568 within processing pipeline 550. Task processing module 543 may send semantic output 570 to one or more of clients 119. As described above, pipeline configuration 544 may provide a definition (e.g., protocol buffer) for semantic output 570 generated by processing pipeline 550, such as by identifying the type of data and/or format of data contained within semantic output 570. Some example definitions are shown in the example of FIG. 5. As shown in the example of FIG. 5 for instance, semantic output 570 may include output data 572A-572N (collectively, “output data 572”) including, segmented scene data 572A, filterable object data 572B, pose data 572C, time delta data 572D, sensor calibration data 572E, ground plane data 572N, or other filterable or unfilterable data. Output data 572 may be based on output of one or more of nodes 568. For example, segmented scene data 572A may correspond to the output of scene segmentation node 568A, filterable object data 572B may correspond to the output of object detection node 568B and/or object tracking node 568E, pose data 572C may correspond to the output of object localization node 568N, and so on and so forth. Time delta data 572D may indicate a difference in collection or other time for sensor data from sensors 522 and ground plane data 572N may describe one or more characteristics, attributes or other features of a ground plane of vehicle 120 (e.g., slope, width, altitude, location).

Sensor calibration data 572E may include data from sensor calibration module 562. Sensor calibration module 562 may store sensor data from various sensors 522 such that the sensor data is synchronized. For example, sensor calibration module 562 may store the most recently collected imaging data, IMU data, and/or other sensor data relative to a timestamp with the timestamp. In this manner, such sensor data is assigned to a common timestamp even though the sensor data may have been collected by different sensors 522 and at different times relative to (e.g., before) the common timestamp. As such, sensor calibration data 572E may include one or more timestamps or the like for sensor data upon which semantic output 570 is based.

Sensor calibration module 562 may also or alternatively calibrate one or more of sensors 522, execute calibration programs for one or more of sensors 522, and store and retrieve calibration data. Sensor calibration module 562 may communicate calibration (e.g., calibration offsets) or other data to sensor fusion module 566, object localization node 568N, or other node 568, such as to improve the accuracy of output generated by these elements. For example, sensor fusion module 566, object localization node 568N, or both may apply one or more calibration offsets received from sensor calibration module 562 in performing sensor fusion or determining a localization for one or more of objects 124, respectively. As such, sensor calibration data 572E may include one or more calibration offsets for sensor data upon which semantic output 570 is based.

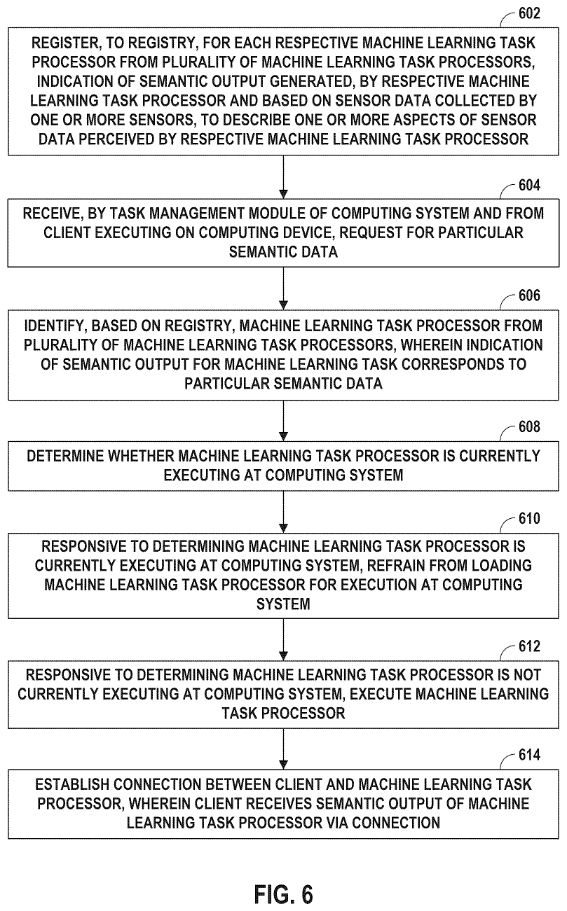

FIG. 6 is a flowchart of an example process for managing machine learning perception tasks on limited hardware resources, in accordance with one or more aspects of the present disclosure. Aspects of FIG. 6 may be described in the context of FIGS. 1-3.

Computing system 110 may register, to a registry 233, for each respective ML task processor from a plurality of ML task processors 115, an indication of a semantic output generated, by the respective ML task processor based on sensor data collected by one or more sensors 122, to describe one or more aspects of the sensor data perceived by the respective ML task processor (602). The one or more aspects of the sensor data perceived by the respective ML task processor may correspond to one or more physical objects, such as one or more of objects 124, detected by the respective ML task processor based on the sensor data. Computing system 110 may be a system of a software defined vehicle, such as vehicle 120.

Computing system 110 may store various information about ML task processors 115 in registry 233. For example, computing system 110 may register (e.g., store), to registry 233, an indication of the sensor data used as input by a respective ML task processor of ML task processors 115 to generate the semantic output of the respective ML task processor. Computing system 110 may route, such as through one or more modules 117, sensor data from sensors 122 to one or more of ML task processors 115 based on the indication of the sensor data used as input by the respective machine learning task processor. As another example, computing system 110 may register, to registry 233, an indication of a task prioritization capability of a respective ML task processor of ML task processors 115. Computing system 110 may execute the respective ML task processor according to the indication of the task prioritization capability for the respective ML task processor.

Computing system 110 may receive, through a task management module 114 of computing system 110 and from a client 119A executing on computing system 110, a request for particular semantic output (604). Computing system 110 may identify, based on registry 233, a ML task processor 115A from ML task processors 115 such that the indication of the semantic output for ML task processor 115A corresponds to the particular semantic output (606). In this manner, computing system 110 may identify, based on registry 233, that ML task processor 115A generates semantic output corresponding to (e.g., matching) the particular semantic output of the request from client 119A. In some examples, the request for the particular semantic output may include an indication of a latency criteria and ML task processor 115A may be identified from machine learning task processors 115 based on a capability of ML task processor 115A to satisfy the latency criteria. For example, computing system 110 may identify ML task processor 115A as being capable of satisfying the latency criteria when a task prioritization capability of ML task processor 115A satisfies the latency criteria.

Computing system 110 may determine whether ML task processor 115A is currently executing at the computing system (608). For example, computing system 110 may register, to registry 233, an indication of whether ML task processor 115A is currently executing. As such, computing system 110 may determine whether ML task processor 115A is currently executing at computing system 110 based on registry 233. Responsive to determining ML task processor 115A is currently executing at computing system 110, computing system 110 may refrain from loading ML task processor 115A for execution at computing device 110 (610). Responsive to determining ML task processor 115A is not currently executing at computing system 110, computing system 110 may execute ML task processor 115A (612).

Computing system 110 may establish a connection between client 119A and ML task processor 115A, such that client 119A receives the semantic output of ML task processor 115A via the connection (614). Computing system 110 may connect individual ML task processors of ML task processors 115 to multiple clients 119. For example, computing system 110 may receive, through task management module 114 and from client 119B executing on computing system 110, a request for particular semantic output that corresponds to the indication of the semantic output of ML task processor 115A. Computing system 110 may determine ML task processor 115A is currently executing at computing system 110. Responsive to determining ML task processor 115A is currently executing at computing system 110, computing system 110 may refrain from loading ML task processor 115A for execution at computing system 110. In addition to the connection established between client 119A and ML task processor 115A, computing system 110 may establish a connection between client 119B and ML task processor 115A and client 119B may receive the semantic output of the ML task processor 115A through the connection.

Computing system 110 may terminate a ML task processor of ML task processors 115 when the ML task processor is not in use. For example, computing system 110 may register, to registry 233, an indication of whether ML task processor 115A is in use by one or more of clients 119. Computing system 110 may terminate execution of ML task processor 115A based on whether ML task processor 115A is in use by one or more of clients 119. For instance, computing system 110 may terminate execution of ML task processor 115A when registry 233 indicates no client of clients 119 is using ML task processor 115A.

This disclosure includes the following examples.

Example 1: A method includes registering, by a computing system and to a registry, for each respective machine learning task processor from a plurality of machine learning task processors, an indication of a semantic output generated, by the respective machine learning task processor and based on sensor data collected by one or more sensors, to describe one or more aspects of the sensor data perceived by the respective machine learning task processor; receiving, by a task management module of the computing system and from a client executing on the computing system, a request for particular semantic output; identifying, by the computing system and based on the registry, a machine learning task processor from the plurality of machine learning task processors, wherein the indication of the semantic output for the machine learning task processor corresponds to the particular semantic output; determining, by the computing system, whether the machine learning task processor is currently executing at the computing system; responsive to determining the machine learning task processor is currently executing at the computing system, refraining, by the computing system, from loading the machine learning task processor for execution at the computing system; responsive to determining the machine learning task processor is not currently executing at the computing system, executing, by the computing system, the machine learning task processor; and establishing, by the computing system, a connection between the client and the machine learning task processor, wherein the client receives the semantic output of the machine learning task processor via the connection.

Example 2: The method of example 1, wherein the connection is a first connection and the client is a first client, the method further includes receiving, by the task management module of the computing system and from a second client executing on the computing system, a request for particular semantic output that corresponds to the indication of the semantic output of the machine learning task processor; determining, by the computing system, the machine learning task processor is currently executing at the computing system; responsive to determining the machine learning task processor is currently executing at the computing system, refraining, by the computing system, from loading the machine learning task processor for execution at the computing system; and establishing, by the computing system, a second connection between a second client and the machine learning task processor, wherein the second client receives the semantic output of the machine learning task processor via the second connection.

Example 3: The method of any of examples 1 and 2, wherein the request for the particular semantic output includes an indication of a latency criteria and the machine learning task processor is identified from the plurality of machine learning task processors based on a capability of the machine learning task processor to satisfy the latency criteria.

Example 4: The method of any of examples 1 through 3, further includes registering, by the computing system and to the registry, an indication of whether the machine learning task processor is currently executing; and determining, by the computing system, whether the machine learning task processor is currently executing at the computing system based on the registry.

Example 5: The method of any of examples 1 through 4, wherein the client is from a plurality of clients, the method further includes registering, by the computing system and to the registry, an indication of whether the machine learning task processor is in use by one or more of the plurality of clients; and terminating, by the computing system, execution of the machine learning task processor based on whether the machine learning task processor is in use by one or more of the plurality of clients.

Example 6: The method of any of examples 1 through 5, further includes registering, by the computing system and to the registry, for each respective machine learning task processor from the plurality of machine learning task processors, an indication of the sensor data used as input by the respective machine learning task processor to generate the semantic output of the respective machine learning task processor; and routing, by the computing system, sensor data from the one or more sensors to the respective machine learning task processor based on the indication of the sensor data used as input by the respective machine learning task processor.

Example 7: The method of any of examples 1 through 6, further includes registering, by the computing system and to the registry, for each respective machine learning task processor from the plurality of machine learning task processors, an indication of a task prioritization capability of the respective machine learning task processor; and executing, by the computing system, the respective machine learning task processor according to the indication of the task prioritization capability for the respective machine learning task processor.

Example 8: The method of any of examples 1 through 7, wherein the one or more aspects of the sensor data perceived by the respective machine learning task processor correspond to one or more physical objects detected by the respective machine learning task processor based on the sensor data.

Example 9: The method of example 8, wherein the one or more sensors include one or more of a camera, a location sensor, or an inertial measurement sensor.

Example 10: The method of any of examples 1 through 9, wherein the computing system is a system of a software defined vehicle.

Example 11: A computing system includes a memory that stores instructions; and one or more processors that execute the instructions to: register, to a registry, for each respective machine learning task processor from a plurality of machine learning task processors, an indication of a semantic output generated, by the respective machine learning task processor and based on sensor data collected by one or more sensors, to describe one or more aspects of the sensor data perceived by the respective machine learning task processor; receive, by a task management module of the computing system and from a client executing on the computing system, a request for particular semantic output; identify, based on the registry, a machine learning task processor from the plurality of machine learning task processors, wherein the indication of the semantic output for the machine learning task processor corresponds to the particular semantic output; determine whether the machine learning task processor is currently executing at the computing system; responsive to determining the machine learning task processor is currently executing at the computing system, refrain from loading the machine learning task processor for execution at the computing system; responsive to determining the machine learning task processor is not currently executing at the computing system, execute the machine learning task processor; and establish a connection between the client and the machine learning task processor, wherein the client receives the semantic output of the machine learning task processor via the connection.

Example 12: The computing system of example 11, wherein the connection is a first connection and the client is a first client and the one or more processors execute the instructions to: receive, by the task management module of the computing system and from a second client executing on the computing system, a request for particular semantic output that corresponds to the indication of the semantic output of the machine learning task processor; determine the machine learning task processor is currently executing at the computing system; responsive to determining the machine learning task processor is currently executing at the computing system, refrain from loading the machine learning task processor for execution at the computing system; and establish a second connection between a second client and the machine learning task processor, wherein the second client receives the semantic output of the machine learning task processor via the second connection.

Example 13: The computing system of any of examples 11 and 12, wherein the request for the particular semantic output includes an indication of a latency criteria and the machine learning task processor is identified from the plurality of machine learning task processors based on a capability of the machine learning task processor to satisfy the latency criteria.

Example 14: The computing system of any of examples 11 through 13, wherein the one or more processors execute the instructions to: register, to the registry, an indication of whether the machine learning task processor is currently executing; and determine whether the machine learning task processor is currently executing at the computing system based on the registry.

Example 15: The computing system of any of examples 11 through 14, wherein the client is from a plurality of clients and the one or more processors execute the instructions to: register, to the registry, an indication of whether the machine learning task processor is in use by one or more of the plurality of clients; and terminate execution of the machine learning task processor based on whether the machine learning task processor is in use by one or more of the plurality of clients.

Example 16: The computing system of any of examples 11 through 15, wherein the one or more processors execute the instructions to: register, to the registry, for each respective machine learning task processor from the plurality of machine learning task processors, an indication of the sensor data used as input by the respective machine learning task processor to generate the semantic output of the respective machine learning task processor; and route sensor data from the one or more sensors to the respective machine learning task processor based on the indication of the sensor data used as input by the respective machine learning task processor.

Example 17: The computing system of any of examples 11 through 16, wherein the one or more processors execute the instructions to: register, to the registry, for each respective machine learning task processor from the plurality of machine learning task processors, an indication of a task prioritization capability of the respective machine learning task processor; and execute the respective machine learning task processor according to the indication of the task prioritization capability for the respective machine learning task processor.

Example 18: The computing system of any of examples 11 through 17, wherein the one or more aspects of the sensor data perceived by the respective machine learning task processor correspond to one or more physical objects detected by the respective machine learning task processor based on the sensor data.

Example 19: The computing system of example 18, wherein the one or more sensors include one or more of a camera, a location sensor, or an inertial measurement sensor.

Example 20: The computing system of any of examples 11 through 19, wherein the computing system is a system of a software defined vehicle.

Example 21: Non-transitory computer-readable storage media including instructions that, when executed by one or more processors of a computing system, cause the one or more processors to: register, to a registry, for each respective machine learning task processor from a plurality of machine learning task processors, an indication of a semantic output generated, by the respective machine learning task processor and based on sensor data collected by one or more sensors, to describe one or more aspects of the sensor data perceived by the respective machine learning task processor; receive, by a task management module of the computing system and from a client executing on the computing system, a request for particular semantic output; identify, based on the registry, a machine learning task processor from the plurality of machine learning task processors, wherein the indication of the semantic output for the machine learning task processor corresponds to the particular semantic output; determine whether the machine learning task processor is currently executing at the computing system; responsive to determining the machine learning task processor is currently executing at the computing system, refrain from loading the machine learning task processor for execution at the computing system; responsive to determining the machine learning task processor is not currently executing at the computing system, execute the machine learning task processor; and establish a connection between the client and the machine learning task processor, wherein the client receives the semantic output of the machine learning task processor via the connection.

Example 22: The non-transitory computer-readable storage media of example 21, wherein the connection is a first connection and the client is a first client and the instructions, when executed by the one or more processors, cause the one or more processors to: receive, by the task management module of the computing system and from a second client executing on the computing system, a request for particular semantic output that corresponds to the indication of the semantic output of the machine learning task processor; determine the machine learning task processor is currently executing at the computing system; responsive to determining the machine learning task processor is currently executing at the computing system, refrain from loading the machine learning task processor for execution at the computing system; and establish a second connection between a second client and the machine learning task processor, wherein the second client receives the semantic output of the machine learning task processor via the second connection.

Example 23: The non-transitory computer-readable storage media of any of examples 21 and 22, wherein the request for the particular semantic output includes an indication of a latency criteria and the machine learning task processor is identified from the plurality of machine learning task processors based on a capability of the machine learning task processor to satisfy the latency criteria.

Example 24: The non-transitory computer-readable storage media of any of examples 21 through 23, wherein the instructions, when executed by the one or more processors, cause the one or more processors to: register, to the registry, an indication of whether the machine learning task processor is currently executing; and determine whether the machine learning task processor is currently executing at the computing system based on the registry.

Example 25: The non-transitory computer-readable storage media of any of examples 21 through 24, wherein the client is from a plurality of clients and the instructions, when executed by the one or more processors, cause the one or more processors to: register, to the registry, an indication of whether the machine learning task processor is in use by one or more of the plurality of clients; and terminate execution of the machine learning task processor based on whether the machine learning task processor is in use by one or more of the plurality of clients.

Example 26: The non-transitory computer-readable storage media of any of examples 21 through 25, wherein the instructions, when executed by the one or more processors, cause the one or more processors to: register, to the registry, for each respective machine learning task processor from the plurality of machine learning task processors, an indication of the sensor data used as input by the respective machine learning task processor to generate the semantic output of the respective machine learning task processor; and route sensor data from the one or more sensors to the respective machine learning task processor based on the indication of the sensor data used as input by the respective machine learning task processor.

Example 27: The non-transitory computer-readable storage media of any of examples 21 through 26, wherein the instructions, when executed by the one or more processors, cause the one or more processors to: register, to the registry, for each respective machine learning task processor from the plurality of machine learning task processors, an indication of a task prioritization capability of the respective machine learning task processor; and execute the respective machine learning task processor according to the indication of the task prioritization capability for the respective machine learning task processor.

Example 28: The non-transitory computer-readable storage media of any of examples 21 through 27, wherein the one or more aspects of the sensor data perceived by the respective machine learning task processor correspond to one or more physical objects detected by the respective machine learning task processor based on the sensor data.

Example 29: The non-transitory computer-readable storage media of example 28, wherein the one or more sensors include one or more of a camera, a location sensor, or an inertial measurement sensor.

Example 30: The non-transitory computer-readable storage media of any of examples 21 through 29, wherein the computing system is a system of a software defined vehicle.

Example 31: A computing system including means for performing each step of any combination of the methods of claims 1-10.

Example 32: A computer-program product that includes instructions that cause one or more processors to perform any combination of the methods of examples 1-10.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise random-access memory (RAM), read-only memory (ROM), EEPROM, compact disc read-only memory (CD-ROM) or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of a computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structures suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of inter-operative hardware units, including one or more processors as described above, in conjunction with suitable software and/or firmware.

Various embodiments have been described. These and other embodiments are within the scope of the following claims.

What is claimed is:

1. A method comprising:
registering, by a computing system and to a registry, for each respective machine learning task processor from a plurality of machine learning task processors, an indication of a semantic output generated, by the respective machine learning task processor and based on sensor data collected by one or more sensors, to describe one or more aspects of the sensor data perceived by the respective machine learning task processor;
receiving, by a task management module of the computing system and from a client executing on the computing system, a request for particular semantic output;
identifying, by the computing system and based on the registry, a machine learning task processor from the plurality of machine learning task processors, wherein the indication of the semantic output for the machine learning task processor corresponds to the particular semantic output;
determining, by the computing system, whether the machine learning task processor is currently executing at the computing system;
responsive to determining the machine learning task processor is currently executing at the computing system, refraining, by the computing system, from loading the machine learning task processor for execution at the computing system;
responsive to determining the machine learning task processor is not currently executing at the computing system, executing, by the computing system, the machine learning task processor; and
establishing, by the computing system, a connection between the client and the machine learning task processor, wherein the client receives the semantic output of the machine learning task processor via the connection.

2. The method of claim 1, wherein the connection is a first connection and the client is a first client, the method further comprising:
receiving, by the task management module of the computing system and from a second client executing on the computing system, a request for particular semantic output that corresponds to the indication of the semantic output of the machine learning task processor;
determining, by the computing system, the machine learning task processor is currently executing at the computing system;
responsive to determining the machine learning task processor is currently executing at the computing system, refraining, by the computing system, from loading the machine learning task processor for execution at the computing system; and
establishing, by the computing system, a second connection between a second client and the machine learning task processor, wherein the second client receives the semantic output of the machine learning task processor via the second connection.

3. The method of claim 1, wherein the request for the particular semantic output includes an indication of a latency criteria and the machine learning task processor is identified from the plurality of machine learning task processors based on a capability of the machine learning task processor to satisfy the latency criteria.

4. The method of claim 1, further comprising:
registering, by the computing system and to the registry, an indication of whether the machine learning task processor is currently executing; and
determining, by the computing system, whether the machine learning task processor is currently executing at the computing system based on the registry.

5. The method of claim 1, wherein the client is from a plurality of clients, the method further comprising:
registering, by the computing system and to the registry, an indication of whether the machine learning task processor is in use by one or more of the plurality of clients; and
terminating, by the computing system, execution of the machine learning task processor based on whether the machine learning task processor is in use by one or more of the plurality of clients.

6. The method of claim 1, further comprising:
registering, by the computing system and to the registry, for each respective machine learning task processor from the plurality of machine learning task processors, an indication of the sensor data used as input by the respective machine learning task processor to generate the semantic output of the respective machine learning task processor; and
routing, by the computing system, sensor data from the one or more sensors to the respective machine learning task processor based on the indication of the sensor data used as input by the respective machine learning task processor.

7. The method of claim 1, further comprising:
registering, by the computing system and to the registry, for each respective machine learning task processor from the plurality of machine learning task processors, an indication of a task prioritization capability of the respective machine learning task processor; and
executing, by the computing system, the respective machine learning task processor according to the indication of the task prioritization capability for the respective machine learning task processor.

8. The method of claim 1, wherein the one or more aspects of the sensor data perceived by the respective machine learning task processor correspond to one or more physical objects detected by the respective machine learning task processor based on the sensor data.

9. The method of claim 8, wherein the one or more sensors include one or more of a camera, a location sensor, or an inertial measurement sensor.

10. The method of claim 1, wherein the computing system is a system of a software defined vehicle.

11. A computing system comprising:
a memory that stores instructions; and
one or more processors that execute the instructions to:
register, to a registry, for each respective machine learning task processor from a plurality of machine learning task processors, an indication of a semantic output generated, by the respective machine learning task processor and based on sensor data collected by one or more sensors, to describe one or more aspects of the sensor data perceived by the respective machine learning task processor;
receive, by a task management module of the computing system and from a client executing on the computing system, a request for particular semantic output;
identify, based on the registry, a machine learning task processor from the plurality of machine learning task processors, wherein the indication of the semantic output for the machine learning task processor corresponds to the particular semantic output;
determine whether the machine learning task processor is currently executing at the computing system;
responsive to determining the machine learning task processor is currently executing at the computing system, refrain from loading the machine learning task processor for execution at the computing system;
responsive to determining the machine learning task processor is not currently executing at the computing system, execute the machine learning task processor; and
establish a connection between the client and the machine learning task processor, wherein the client receives the semantic output of the machine learning task processor via the connection.

12. The computing system of claim 11, wherein the connection is a first connection and the client is a first client and the one or more processors execute the instructions to:
receive, by the task management module of the computing system and from a second client executing on the computing system, a request for particular semantic output that corresponds to the indication of the semantic output of the machine learning task processor;
determine the machine learning task processor is currently executing at the computing system;
responsive to determining the machine learning task processor is currently executing at the computing system, refrain from loading the machine learning task processor for execution at the computing system; and
establish a second connection between a second client and the machine learning task processor, wherein the second client receives the semantic output of the machine learning task processor via the second connection.

13. The computing system of claim 11, wherein the request for the particular semantic output includes an indication of a latency criteria and the machine learning task processor is identified from the plurality of machine learning task processors based on a capability of the machine learning task processor to satisfy the latency criteria.

14. The computing system of claim 11, wherein the one or more processors execute the instructions to:
register, to the registry, an indication of whether the machine learning task processor is currently executing; and
determine whether the machine learning task processor is currently executing at the computing system based on the registry.

15. The computing system of claim 11, wherein the client is from a plurality of clients and the one or more processors execute the instructions to:
register, to the registry, an indication of whether the machine learning task processor is in use by one or more of the plurality of clients; and
terminate execution of the machine learning task processor based on whether the machine learning task processor is in use by one or more of the plurality of clients.

16. The computing system of claim 11, wherein the one or more processors execute the instructions to:
register, to the registry, for each respective machine learning task processor from the plurality of machine learning task processors, an indication of the sensor data used as input by the respective machine learning task processor to generate the semantic output of the respective machine learning task processor; and
route sensor data from the one or more sensors to the respective machine learning task processor based on the indication of the sensor data used as input by the respective machine learning task processor.

17. The computing system of claim 11, wherein the one or more processors execute the instructions to:
register, to the registry, for each respective machine learning task processor from the plurality of machine learning task processors, an indication of a task prioritization capability of the respective machine learning task processor; and
execute the respective machine learning task processor according to the indication of the task prioritization capability for the respective machine learning task processor.

18. The computing system of claim 11, wherein the one or more aspects of the sensor data perceived by the respective machine learning task processor correspond to one or more physical objects detected by the respective machine learning task processor based on the sensor data.

19. The computing system of claim 11, wherein the computing system is a system of a software defined vehicle.

20. Non-transitory computer-readable storage media comprising instructions, that when executed by one or more processors of a computing system, cause the one or more processors to:
register, to a registry, for each respective machine learning task processor from a plurality of machine learning task processors, an indication of a semantic output generated, by the respective machine learning task processor and based on sensor data collected by one or more sensors, to describe one or more aspects of the sensor data perceived by the respective machine learning task processor;
receive, by a task management module of the computing system and from a client executing on the computing system, a request for particular semantic output;
identify, based on the registry, a machine learning task processor from the plurality of machine learning task processors, wherein the indication of the semantic output for the machine learning task processor corresponds to the particular semantic output;
determine whether the machine learning task processor is currently executing at the computing system;
responsive to determining the machine learning task processor is currently executing at the computing system, refrain from loading the machine learning task processor for execution at the computing system;
responsive to determining the machine learning task processor is not currently executing at the computing system, execute the machine learning task processor; and
establish a connection between the client and the machine learning task processor, wherein the client receives the semantic output of the machine learning task processor via the connection.
